(19) United States
(12) Patent Application Publication
(10) Pub. No.: US 2009/0287414 A1
(43) Pub. Date: Nov. 19, 2009

(54) SYSTEM AND PROCESS FOR THE PRECISE POSITIONING OF SUBSEA UNITS

(75) Inventor: Keith Vickery, Houston, TX (US)

Correspondence Address: EGBERT LAW OFFICES, 412 MAIN STREET, 7TH FLOOR, HOUSTON, TX, 77002, US

(73) Assignee: ZUPT, LLC, Houston, TX (US)

(21) Appl. No.: 11/748,279

(22) Filed: May 14, 2007

(51) Int. Cl. G01C 21/10; H04B 1/59

(52) U.S. Cl. 701/220; 367/6

(57) ABSTRACT

A system for precise positioning of subsea units has a remotely operated vehicle, an inertial measurement unit positioned on the vehicle so as to produce a signal relative to a position of the subsea unit, a doppler velocity log coupled to the vehicle in producing a signal relative to the position of the subsea unit, a baseline measurement device coupled to the vehicle and producing a signal relative to the position of the subsea unit, a Kalman filter cooperative with the signals from the inertial measurement unit and the doppler velocity log and the baseline measurement device, and a processor cooperative with the Kalman filter for producing an output indicative of the positioning of the subsea unit. A doppler velocity log includes a plurality of beams which are individually connected to the Kalman Filter.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to processes and systems for the precise positioning of subsea units. More particularly, the present invention relates to the integrated use of inertial measurement units, doppler velocity logs and baseline measurement devices for producing a Kalman-filtered output indicative of subsea position.

2. Description of Related Art Including Information Disclosed Under 37 CFR 1.97 and 37 CFR 1.98.

Few techniques presently exist for reliable three-dimensional position sensing for underwater vehicles. Depth, altitude, heading and roll/pitch attitude can all be instrumented with high bandwidth internal sensors. XY position, in contrast, remains difficult to instrument and is normally measured acoustically in oceanographic and commercial applications.

Conventional long-baseline acoustic navigation systems require multiple fixed transponders, i.e., fixed or moored on the sea floor, on the hull of a surface ship, or on sea-ice. With a maximum acoustic range of 5 to 10 kilometers, fixed long-baseline networks can cover only limited mission areas. Moreover, existing long-baseline navigation systems are designed to navigate one vehicle per interrogation-response acoustic cycle during a time division multiple access scheme. This is acceptable for single vehicle deployments, but less desirable for multi-vehicle deployments because the interrogation-response navigation update period increases linearly with the number of vehicles (thereby proportionately decreasing each vehicle's overall navigation update rate). In practice, this limits multi-vehicle log baseline navigation to networks of a few vehicles. The existing prevalence of long baseline systems within the oceanographic community is due to a lacuna of alternative means for obtaining bounded-error subsea XY position.

While the advent of the global positioning systems allows bounded-error terrestrial navigation for both surface and air vehicles, seawater is opaque to the radio-frequencies upon which GPS relies and, thus, GPS cannot be used by submerged underwater vehicles. Though ultra-short-baseline acoustic navigation systems are preferred for short-range navigation, they are of limited usefulness for long-range navigation and, furthermore, also suffer from the same update problem as long baseline navigation systems.

The high cost and power consumption of inertial navigation systems has, until now, precluded their widespread use in non-military undersea vehicles. Compact, low-cost, low-power inertial navigation systems have recently become commercially available so as to offer an alternative method for instrumenting absolute XYZ displacement. Modern commercial navigation system position error is in the order of one percent of path-length, hence, inertial navigation systems alone are inadequate to support the needs of long-range bounded-error navigation.

Acoustic doppler current profilers are types of sonar that attempt to produce a record of water current velocities over a range of depths. The most popular acoustic doppler current profilers use a scheme of four ceramic transducers which work in water similar to loudspeakers in air. These transducers are aimed in such a way that the monofrequency, sound pulse they produce travels through the water in four different, but known directions. If the acoustic doppler current profiler is looking down into the water, each transducer would be aligned at 12, 3, 6 and 9 o'clock positions facing away from the perimeter of the clock. These are tilted down 90 degrees in elevation below the horizon. As the echo of the sound is returned by scatterers in the water, it is shifted in frequency due to the doppler effect. In addition to the transducers, the acoustic doppler current profiler typically has a receiver, an amplifier, a clock, a temperature sensor, a compass, a pitch-and-roll sensor, analog-to-digital converters, memory, digital signal processors and an instruction set. The analog-to-digital converters and digital signal processors are used to sample the returning signal, determine the doppler shift, and sample the compass and other sensors. Trigonometry, averaging and some critical assumptions are used to calculate the horizontal velocity of the group of echoing scatters in a volume of water. By repetitive sampling of the return echo, and by “gating” the return data in time, the acoustic doppler current profiler can produce a profile of the water currents over a range of depths.

The acoustic doppler current profiler can also be an acoustic doppler velocity log if it is programmed with the correct signal processing logic. The doppler velocity log bounces sound off of the bottom and can determine the velocity vector of a subsea vehicle moving across the sea floor. This information can be combined with a starting fix to calculate the position of the vehicle. Doppler velocity logs are used to help navigate submarines, autonomous underwater vehicles, and remotely-operated vehicles for precise positioning in an environment where GPS, and other navigational aids, will not work.

Long baseline systems consist of an array of at least three transponders. The initial position of the transponders is determined by USBL and/or by measuring the baselines between the transponders. Once that is done, only the ranges to the transponders need to be measured to determine a relative position. The positions should theoretically be located at the intersection of the imaginary spheres, one around each transponder, with a radius equal to the time between transmission and reception multiplied by the speed of sound through the water. Because angle measurement is not necessary, the accuracy in great water depths is better than ultra-short baseline measurement.

The inertial measurement unit is a closed system that is used to detect altitude, location and motion. Typically installed in aircrafts, it normally uses a combination of accelerometers and angular rate sensors (i.e., gyroscopes) to track how long the craft is moving and where it is. Typically, an inertial measurement unit detects the current acceleration and rate of change in attitude, (i.e. pitch, roll and yaw rates) and then sums them to find the total change from the initial position. IMU's typically suffer from accumulated error. Because an IMU is continually adding detected changes to the current position, any error in the measurement is accumulated. This leads to “drift”, or an ever increasing error between what the IMU thinks the position is and the actual position. IMU's are normally one component of a navigation system. Other systems such as GPS (used to correct for long term drift in position), a barometric system (for altitude correction), or a magnetic compass (for attitude correction) compensate for the limitations of an IMU. The IMU will typically contain three accelerometers and 3 gyroscopes. The accelerometers are placed such that their measuring axes are orthogonal to each other. They measure so-called “specific forces” (inertial acceleration—gravity). Three gyros are placed such that their measuring axis are orthogonal to each other so as to measure the rotation rates.

As stated previously, each of these systems has its own problems. Often, the problems will result in the transmitted signal to accumulating “noise” over time. This “noise” is the error in the measured data as the result of the particular problems associated with each of these systems. As stated herein before, inertial measurement units tend to have very accurate initial measurements but tend to accumulate error over time. The doppler velocity logs require that all of the transducers work perfectly in order to achieve the requisite data. If any of the transducers should fail or if any of the transducers should become misaligned, then the positioning data from such doppler velocity logs can become compromised. Often, the analysis from a doppler velocity log is terminated whenever one of the transducers should fail to work or should go into misalignment. The long baseline measurement systems require a great deal of time and effort to install. Initially, each of the transponders must be installed on the ocean floor at a precise location. Once these are installed in the precise location, then the movement of the ROV through this array of transponders can be monitored very accurately. However, in many circumstances, a cable will run from the ROV to a ship whereby the “ping” for the initiation of the acoustic signal is ordered from the ship and the data is accumulated by way of the long line extending from the ROV to the ship on the surface of the water. As a result, there is some time delay in the transmission of the signal from the ROV to the ship. Pressure transducers are only effective at measuring the depth of the ROV and do not provide effective information regarding the position of the ROV beyond the depth measurement. As such, a need is developed so as to create a processing system which would overcome the problems associated with each of the components of the prior art.

In the past, various patents have issued related to systems for the tracking of various vehicles. For example, U.S. Pat. No. 7,132,982, issued on Nov. 7, 2006 to Smith et al., describes a direct multilateration target tracking system that is provided with a TOA time stamp as an input. The system includes a technique of tracking targets with varying receiver combinations. A method is provided for correlating and combining various modes of messages to enhance target tracking in a passive surveillance system. The system provides a technique for selecting the best receiver combination and/or solution of multilateration equations from a multitude of combinations.

U.S. Pat. No. 7,171,303, issued to Nordmark et al., provides a navigation method and apparatus for generating at least one high-accuracy navigation parameter. This system includes a relative sensor system adapted to register relative movements of the apparatus in response thereto to produce one relative data signal. A radio receiver system is adapted to receive navigation data signals from a plurality of external signal sources so as to produce at least one tracking data signal. The radio receiver system includes a central processing unit adapted to receive the tracking data signal, receive the relative data signal, and produce at least one navigation parameter. A clock unit is adapted to produce a first clock signal to form a sampling basis in the radio receiver system and a second clock signal to form a sampling basis in the relative sensor system. A common software module is adapted to realize at least one function of the radio receiver system and at least one function of the relative sensor system. The common software module includes the central processing unit which includes a Kalman filter.

U.S. Pat. No. 7,046,188, issued to Zaugg, et al., provides an active tracking system that has a Kalman filter used to track a target while the plurality of detections occur within a gate over a period of time. A blind-zone particle filter is used to concurrently propagate with the Kalman Filter when an absence of detections occur with the gate following the polarity of detections until a probability that the target is in a blind zone exceeds a threshold. An unrestricted-zone particle filter is provided to concurrently propagate with the blind-zone particle filter after a gated detection is received and while a probability that the target is in an unrestricted zone exceeds a threshold. A controller is provided to return the Kalman filter to tracking the target when a covariance of the unrestricted-zone particle filter falls below a predetermined covariance.

It is an object of the present invention to provide a process and system for the precise positioning of subsea units which is very reliable and very accurate.

It is another object of the present invention to provide a process and system for position detection that enhances productivity.

It is a further object of the present invention to provide a positioning system that can be carried out in poor visibility conditions.

It is another object of the present invention to provide a positioning system which optimizes safety.

It is still another object of the present invention to provide a positioning system that allows for dynamic measurement of subsea position.

It is a further object of the present invention to provide a positioning system that can compensate for the errors found in existing systems so as to produce an improved result through the use of a Kalman filter.

It is still another object of the present invention to provide a positioning system and process which avoids any time delay from the transmission of signals to the surface of the water during long baseline measurement.

It is still a further object of the present invention to provide a positioning system and process which avoids any problems associated with the failure of one or more transducers associated with a doppler velocity log.

These and other objects and advantages of the present invention will become apparent from a reading of the attached specification and appended claims.

### BRIEF SUMMARY OF THE INVENTION

The present invention is a system for the precise measurement of subsea units that comprises a remotely operated vehicle, an inertial measurement unit positioned on the remotely operated vehicle so as to produce a signal relative to a position of the subsea unit, a doppler velocity log coupled to the remotely operated vehicle so as to produce a signal relative to the position of the subsea unit, a baseline measurement device coupled to the remotely operated vehicle for producing a signal relative to the position of the subsea unit, a Kalman filter cooperative with the signal from the inertial measurement unit, the doppler velocity log and the baseline measurement device. A processing means is cooperative with the Kalman filter for producing an output indicative of the position of the subsea unit.

In the present invention, the doppler velocity log has a plurality of beams. The Kalman filter is coupled individually to this plurality of beams. The baseline measurement device includes a transmitter affixed to the remotely operated vehicle, a receiver affixed to the remotely operated vehicle, and a transponder positioned on a subsea surface. The transponder means is interactive with the transmitter and the receiver for producing the signal relative to the position of the subsea unit. The receiver time tags a signal as passed by the transmitter immediately as the signal is transmitted.

There is a pressure transducer that is connected to the remotely operated vehicle and cooperative with the Kalman filter for producing a signal relative to a depth of the remotely operated vehicle. The processing means records data from the Kalman filter in relation to time. The processing means can include a UART interposed between the inertial measurement unit and the doppler velocity log and the baseline measurement device. The processing means also includes a time-tagging means coupled to the UART for time-tagging data immediately upon receipt by the UART.

The remotely operated vehicle can be either a towfish, a cable-connected remotely operated vehicle or a non-cable connected remotely operated vehicle. The transponder can include a pair of transponders positioned on the subsea surface. Each of the pair of transponders is placed in a desired position relative to a path of travel of the remotely operated vehicle. A clock is cooperative with the processing means for assigning a time relative to the signals as received from the Kalman filter. The Kalman filter serves to compensate for any deviations occurring between the signals received from the inertial measurement unit, the doppler velocity log and the baseline measurement device.

The present invention is also a process for determining a precise position of a subsea unit comprised of the steps of: (1) producing a first signal from an inertial measurement unit relative to the position to the subsea unit; (2) producing a second signal from a doppler velocity log relative to the position of the subsea unit; (3) producing a third signal from a baseline measurement device relative to the position of the subsea unit; (4) Kalman filtering the first signal, the second signal and the third signal so as to compensate for any deviations between the signals so as to produce a measurement signal; and (5) processing the measurement signal so as to produce an output indicative of the precise position of the subsea unit.

The process of the present invention also includes the step of emitting a plurality of beams from the doppler velocity log such that the second signal is transmitted from each of the plurality of beams. The process also includes the steps of placing at least a pair of transducers on a subsea surface, transmitting an acoustic signal from the subsea unit to the transponders, and receiving the acoustic signals by the subsea unit. The acoustic signal is timed-tagged immediately upon transmission by the subsea unit. The receiver is positioned in proximity to the transmitter on the subsea unit. The receiver time tags the acoustic signal upon an initiation of the transmission by the transmitter. The subsea unit is moved relative to the transponders during the steps of transmitting and receiving.

The method of the present invention can also include producing a fourth signal from a pressure transducer relative to a depth of the subsea unit, and Kalman filtering the fourth signal so as to compensate for any deviations between the fourth signal and the first, second and third signals. The measurement signals are time-tagged immediately prior to the step of processing.

### BRIEF DESCRIPTION OF THE SEVERAL VIEWS OF THE DRAWINGS

FIG. 1 is a diagrammatic illustration of the use of the system and process of the present invention.

FIG. 2 is a block diagram showing the process of the present invention.

FIG. 3 is a block diagram illustrating, with greater detail, the particular components of the system of the present invention for providing precise position information.

FIG. 4 is an illustration of the operation of the doppler velocity log as used in the system of the present invention.

FIG. 5 is an illustration showing the operation of the baseline measurement device as used in the system of the present invention.

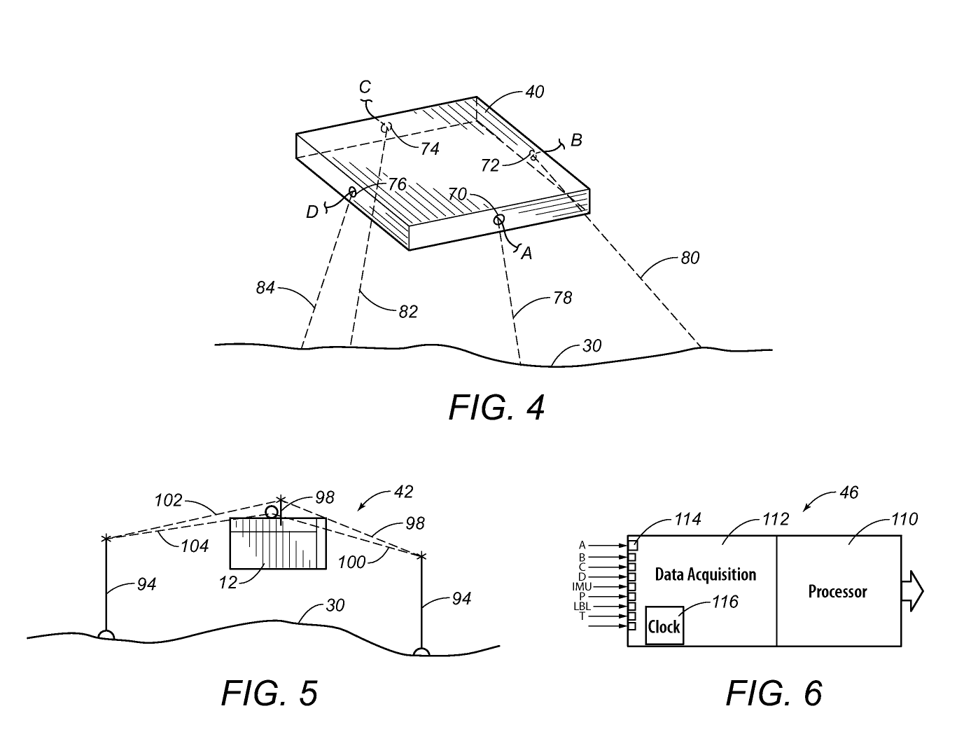

FIG. 4 is a block diagram showing the processing means as used in the system and process of the present invention.

### DETAILED DESCRIPTION OF THE INVENTION

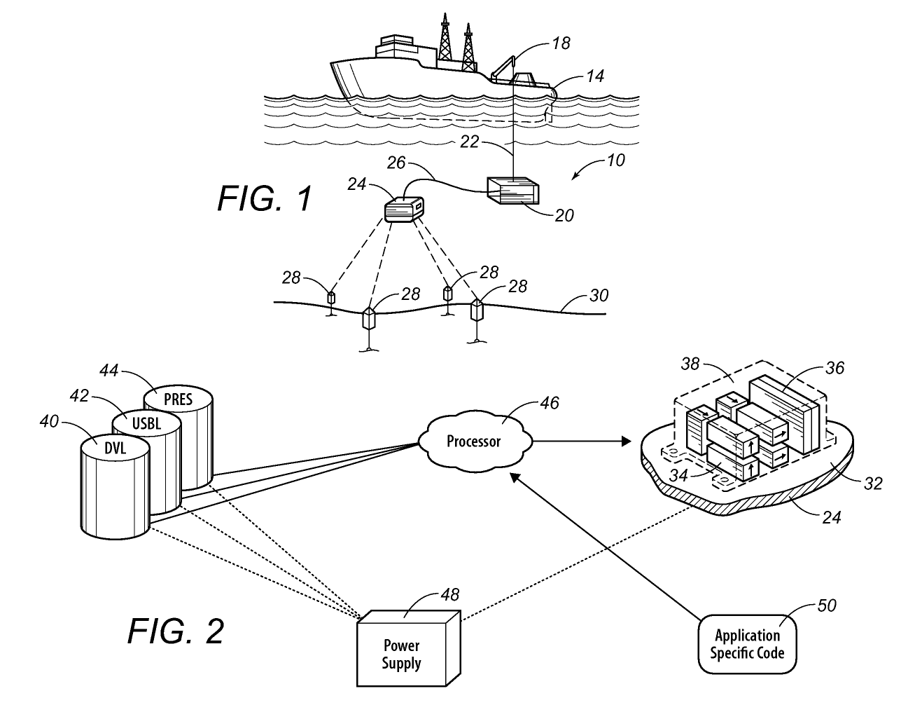

Referring to FIG. 1, there is shown the process 10 of the present invention for determining the precise position of a subsea unit 12. As can be seen in FIG. 1, a ship 14 is located on the surface 16 of a body of water. A davit 18 is used to lower a housing 20 connected to a cable 22. The housing 20 receives the ROV 24 therein. When the housing 20 has been delivered to a precise location below the surface 16 of the water, the ROV 24 can be activated so as to pass from the interior of the housing 20 and outwardly thereof. A tether 26 will continue to connect the ROV 24 to the housing 20. The ROV 24 will include the electronics associated with the system of the present invention. In particular, the ROV 24 will contain a cylindrical unit that contains the baseline measurement device, the inertial measurement unit and the doppler velocity log. A plurality of transponders 28 are positioned in an array on the subsea surface 30. The transponders 28 will communicate with a transmitter and a receiver (as will be described hereinafter in association with FIG. 5) on the subsea unit 20. Through the system of the present invention, the precise position of the subsea unit 12 can be determined in a very accurate manner.

FIG. 2 illustrates, in a simplified manner, the system of the present invention. As can be seen, the inertial measurement unit 32 is secured to the ROV 24 within the interior thereof. The inertial measurement unit 32 is in the nature of a conventional inertial measurement unit having suitable gyroscopes 34 and a processor 36 thereon. The gyroscopes 34 and the processor 36 are housed hermitically within a chamber 38. Typically, the inertial measurement unit 32 will provide the most accurate information regarding the position of the subsea unit 12. From the initial “home” position, the inertial measurement unit 32 will provide the most accurate data as it moves away from the home position. However, as movement continues, and as stated previously, the accuracy of the data will tend to deteriorate. As such, additional information will be need to be coupled with the data from the inertial measurement unit 32 so as to provide a more accurate picture as to the proper position of the subsea unit 12. In particular, the doppler velocity log 40, the baseline measurement device 42 and a pressure sensor 44 can be coupled to a processor 46 so as to supplement the data provided by the inertial measurement unit 32. A power supply 48 will supply power to both the inertial measurement unit 32, the doppler velocity log 40, the baseline measurement device 42 and the pressure transducer 44. An application specific code 50 can be introduced in the processor 46 so as to provide additional requisite data regarding the survey upon which the ROV 24 is employed.

From the diagram of FIG. 2, it can be seen that the data from the doppler velocity log 40, the baseline measurement device 42 and the pressure transducer 44 is utilized so as to cause the data from the inertial measurement unit 32 to become more accurate. The processor 46 will process the data such that, as the inertial measurement unit 32 starts to move further from its “home” position and at which time the information secured from the inertial measurement unit 32 is less accurate, the data from the other resources 40, 42 and 44 may be interpreted by the processor 46 as being more important or more accurate in the evaluation of the precise position. Additionally, the processor 46 will tend to utilize the information from all of the resources available to it so as to assure that there is a consistency in measurement. If one of the resources 32, 40, 42 and 44 produces clearly erroneous data, then the processor 46 can either ignore such data or to incorporate the data, through a suitable algorithm, during the evaluation of the position of the subsea unit 12.

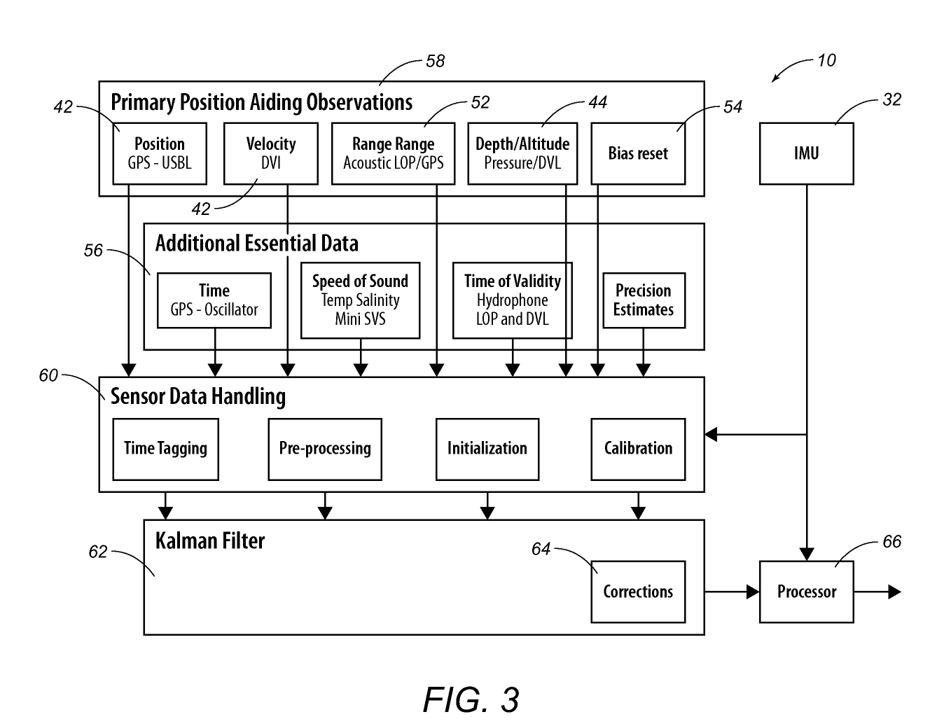

FIG. 3 illustrates the process 10 of the present invention as utilized for the analysis of data. In particular, the “Primary Position Aiding Observations” show the various resources 32, 40, 42 and 44 from FIG. 2. The position of the subsea unit 12 can be determined by either a GPS measurement or from the ultra-short baseline measurement 42. The velocity of the subsea unit 12 would be typically secured through the doppler velocity log 42. The range is determined by the acoustic LOP/GPS as is illustrated in block 52. The depth of the subsea unit can be determined most prominently by the pressure transducer 44 or also by the doppler velocity log 40. Additionally, a suitable bias reset 54 can be provided as required by the particular systems employed.

An “Additional Essential Data” block 56 allows further information to be provided during the processing of the “Primary Position Aiding Observations” block 58. This “Additional Essential Data” can include time (as measured by the GPS), the speed of sound, the time of validity, and other precision estimates. The information from the “Primary Position Aiding Observations” block 58 and “Additional Essential Data” block 56 are transmitted as an input into the “Sensor Data Handling” block 60. In the Sensor Data Handling, the signals are time-tagged, preprocessed, initialized and calibrated. The signals are then transmitted to Kalman filter 62. Kalman filter 62 will analyze the data and correct the data, as required in corrections block 64, prior to being delivered to processor 66.

The Kalman filter 62 is a recursive estimator. This means that only the estimated state from the previous time step and the current measurement are needed to compute the estimate for the current state. In contrast to batch estimation techniques, no history of observations and/or estimates is required. It is unusual in being purely a time domain filter. Most filters (for example, a low-pass filter) are formulated in the frequency domain and then transformed back to the time domain for implementation. The Kalman filter has two distinct phases: predict and update. The predict phase uses the estimate from the previous time step to produce an estimate of the current state. In the update phase, measurement information from the current time step is used to refine this prediction to arrive at a new, more accurate estimate. As such, the Kalman filter provides an accurate estimate in the state of a dynamic system from a series of incomplete and noisy measurements. The Kalman filter exploits the dynamics of the target, which govern its time evolution, to remove the effects of the noise and to obtain a good estimate of the location of the target at the present time (filtering), at a future time (prediction), or at a time in the past (interpolation or smoothing).

The inertial measurement unit 32 transmits its signal directly to the processor 66 or to the Sensor Data Handling block 60. As such, the Kalman filter 62 can reconcile the signal from the inertial measurement unit 32 with the data from the Primary Position Aiding Observations block 58 so as to allow the processor 66 to determine the precise position of the subsea unit 10.

FIG. 4 is an illustration of the unique aspect of the doppler velocity log 40 as used in the system of the present invention. As can be seen, the doppler velocity log 40 emits beams from transducers 70, 72, 74 and 76. It can be seen that the transducers 70, 72, 74 and 76 are aimed so that the monofrequency sound pulse travels through the water in four different, but known, directions. Each of the transducers 70, 72, 74 and 76 are offset 90° from each other. The transducer 70 transmits a beam 78 toward the sea floor 30. Transducer 72 transmits a beam 80 to the sea floor 30. Transducer 74 transmits a beam 82 to the sea floor 30. Finally, transducer 76 transmits a beam 84 to the sea floor 30. Each of the transducers 70, 72, 74 and 76 has a separate line that is connected thereto. As can be seen, transducer 70 has line “A” extending therefrom. Transducer 72 has line “B” extending therefrom. Transducer 74 has line “C” extending therefrom. Transducer 76 has line “D” extending therefrom. As such, unlike the prior art, rather than coupling each of the lines A, B, C and D to a central processor on the doppler velocity log 40, the data from each of the transducers 70, 72, 74 and 76 is delivered as separate inputs to the processor of the present invention. As such, if there is a failure of a single one of the transducers 70, 72, 74 and 76, then the data from the doppler velocity log 40 is not lost. Since the present invention utilizes the data from the doppler velocity log 40 to “supplement” or to enhance the data from the inertial measurement unit, the loss of one of the transducers 70, 72, 74 and 76 will not materially affect the ultimate data which is used for determining the accuracy of the inertial measurement unit. As such, there is no need to shut down the system if any of the transducers should become lost during the operation of the doppler velocity log. The remaining data can still be used for the purposes of the present invention.

FIG. 5 shows the operation of the baseline measurement device 42 of the present invention. In FIG. 5, it can be seen that there is a transmitter 90 that extends from the subsea unit 12. A receiver 92 is positioned in proximity to the transmitter 90. A pair of transponders 94 and 96 are positioned on the sea floor 30 in a conventual manner. Unlike the prior art, there is no cable that extends from the subsea unit 12 to the surface 16 of the water. As such, the present invention eliminates the delay in the transmission of the signals. Since the receiver 92 is located in proximity to the transmitter 90, as soon as the transmitter 90 emits a “ping”, the receiver 92 can time tag such a signal instantaneously. As such, through the processor of the present invention, the initiation of the transmitted signal occurs in real time and there is no loss of accuracy in the position of the subsea unit through the delay in communication to the surface. In order to determine the position of the subsea unit, the transmitter 90 sends a signal 98 towards the transponder 94. Transponder 94 will reflect the signal as an acoustic wave 100 back to the receiver 92. Similarly, the transmitter 90 will send an acoustic signal 102 towards the transponder 96. This signal is reflected back as reflected acoustic wave 104. Relative position of the subsea unit 12 between the transponders 94 and 96 will allow the processor to gauge the position of the subsea unit 12.

FIG. 6 shows the processor 46 of the present invention. The processor 46 includes the processing unit 110 and a data acquisition unit 112. It can be seen that the various inputs are transmitted to the serial data ports 114 of the data acquisition unit 112. A clock 116 immediately time tags the data upon receipt by the serial ports 114. It can be seen in FIG. 6 that the lines A, B, C and D from the doppler velocity log 40 enter as separate serial inputs to the data acquisition unit 12. Additionally, the inertial measurement unit, the pressure transducer, the baseline measurement device and a temperature measurement unit are also provided as serial inputs. The data acquisition unit 112 includes a UART. The UART is a universal asynchronous receiver/transmitter. This is a piece of computer hardware that translates data between parallel and serial interfaces. As used herein, the UART converts bytes of data to and from asynchronous start-stop bit streams represented as binary electrical impulses. Since the bits have to be moved from one place to another using wires or some other medium, the expense of the wires can become large. In order to reduce the expense of long communication lines carrying several bits in parallel, the data bits are sent sequentially, one after another, using the UART to convert the transmitted bits between sequential and parallel. The UART contains a shift register which is the fundamental method of conversion between serial and parallel forms. The UART enhances the ability to receive and transmit serial data using different serial bit rates. By time tagging the data, and recording such data, the history of movement of the subsea unit 12 can be definitely analyzed following the positioning operation.

The foregoing disclosure and description of the invention is illustrative and explanatory thereof. Various changes in the details of the illustrated system or in the steps of the described method can be made within the scope of the appended claims without departing from the true spirit of the invention. The present invention should only be limited by the following claims and their legal equivalents.

I claim:

1. A system for precise positioning of subsea units comprising:
a remotely operated vehicle;
an inertial measurement unit positioned on said remotely operated vehicle, said inertial measurement unit producing a signal relative to a position of the subsea unit;
a doppler velocity log coupled to said remotely operated vehicle, said doppler velocity log producing a signal relative to the position of the subsea unit;
a baseline measurement device coupled to said remotely operated vehicle, said baseline measurement device producing a signal relative to the position of the subsea unit;
a Kalman filtering means cooperative with the signals from said inertial measurement unit and said doppler velocity log and said baseline measurement device; and
a processing means cooperative with said Kalman filtering means for producing an output indicative of the position of the subsea unit.

2. The system of claim 1, said doppler velocity log having a plurality of beams, said Kalman filtering means coupled individually to said plurality of beams.

3. The system of claim 1, said baseline measurement device comprising:
a transmitter affixed to said remotely operated vehicle;
a receiver affixed to said remotely operated vehicle; and
a transponder means positioned on a subsea surface, said transponder means interactive with said transmitter and said receiver for producing the signal relative to the position of the subsea unit.

4. The system of claim 3, said receiver time tagging a signal as passed by said transmitter immediately as the signal is transmitted by said transmitter.

5. The system of claim 1, said doppler velocity log being tightly coupled to said Kalman filtering means.

6. The system of claim 1, further comprising:
a pressure transducer means connected to said remotely operated vehicle and cooperative with said Kalman filtering means for producing a signal relative to a depth of said remotely operated vehicle.

7. The system of claim 1, said processing means for recording data from said Kalman filtering means in relation to time.

8. The system of claim 1, said processing means comprising:
a UART interposed between said inertial measurement unit and said doppler velocity log and said baseline measurement device; and
a time-tagging means coupled to said UART for time tagging data immediately upon receipt by said UART.

9. The system of claim 1, said remotely operated vehicle selected from the group consisting of a towfish, a cable-connected remotely operated vehicle, and a non-cable connected remotely operated vehicle.

10. The system of claim 3, said transponder means comprising:
a pair of transponders positioned on the subsea surface, each of said pair of transponders placed in a desired position relative to a path of travel of said remotely operated vehicle.

11. The system of claim 1, further comprising:
a clock means cooperative with said processing means for assigning a time relative to the signals as received from said Kalman filtering means.

12. The system of claim 1, said Kalman filtering means for compensating for deviations occurring between the signals received from said inertial measurement unit and said doppler velocity log and said baseline measurement device.

13. A process for determining a precise position of a subsea unit comprising:
producing a first signal from an inertial measurement unit relative to the position of the subsea unit;
producing a second signal from a doppler velocity log relative to the position of the subsea unit;
producing a third signal from a baseline measurement device relative to the position of the subsea unit;
Kalman filtering said first signal and said second signal and said third signal so as to compensate for any deviations between said signals so as to produce a measurement signal; and
processing the measurement signal so as to produce an output indicative of the precise position of the subsea unit.

14. The process of claim 13, further comprising:
emitting a plurality of beams from said doppler velocity log, said second signal being transmitted from each of said plurality of beams.

15. The process of claim 13, further comprising:
placing at least a pair of transponders on a subsea surface;
transmitting an acoustic signal from the subsea unit to the transponder; and
receiving the acoustic signals by the subsea unit.

16. The process of claim 15, further comprising:
time tagging the acoustic signal immediately upon transmitting by the subsea unit.

17. The process of claim 16, further comprising:
positioning a receiver in proximity to a transmitter on the subsea unit, said receiver time tagging the acoustic signal upon an initiation of transmission by the transmitter.

18. The process of claim 15, further comprising:
moving the subsea unit relative to the transponders during the step of transmitting and receiving.

19. The process of claim 13, further comprising:
producing a fourth signal from a pressure transducer relative to a depth of the subsea unit; and
Kalman filtering said fourth signal so as to compensate for any deviations between said fourth signal and said first, second and third signals.

20. The process of claim 13, further comprising:
time tagging the measurement signal immediately prior to said step of processing.
